(19) United States
(12) Patent Application Publication
(10) Pub. No.: US 2023/0158949 A1
(43) Pub. Date: May 25, 2023

(54) Device and Method for External Communication by a Vehicle

(71) Applicant: Bayerische Motoren Werke Aktiengesellschaft, Muenchen (DE)

(72) Inventors: Philipp KERSCHBAUM, Muenchen (DE); Felix LAUBER, Muenchen (DE); Desiree MEYER, Stockdorf (DE); Frederik PLATTEN, Muenchen (DE)

(21) Appl. No.: 17/920,286

(22) PCT Filed: Mar. 9, 2021
(86) PCT No.: PCT/EP2021/055841

§ 371 Date: Oct. 20, 2022

(30) Foreign Application Priority Data
Apr. 21, 2020 (DE) 10 2020 110 777.3

(51) Int. Cl. B60Q 1/50; B60Q 1/48; B60Q 3/283; B62D 1/04; B60R 25/24

(52) U.S. Cl. CPC B60Q 1/543; B60Q 1/486; B60Q 3/283; B62D 1/046; B60R 25/24

(57) ABSTRACT

A device for providing external communication by a vehicle is provided. The vehicle includes a steering wheel having one or more light-emitting elements in a passenger compartment of the vehicle. The device is configured to ascertain external information that needs to be communicated to a user of the vehicle who is arranged outside of the passenger compartment of the vehicle. The device is furthermore configured to prompt the one or more light-emitting elements to generate a light signal in order to display the external information.

### BACKGROUND AND SUMMARY

The invention relates to a device and to a method that enable efficient and reliable external communication by a vehicle.

It may be necessary and/or advantageous for a motor vehicle, in particular for a passenger vehicle, to communicate information, such as the state of charge of the vehicle battery and/or the interior temperature in the interior of the vehicle, to a user who is located outside the passenger compartment or outside the interior of the vehicle. The information should be gatherable by the user in a reliable and comfortable manner.

The present document concerns the technical object of efficiently enabling reliable and comfortable external communication by a vehicle.

The aforementioned object is achieved by the claimed invention. Advantageous embodiments are described, among other things, in the dependent claims. It should be pointed out that additional features of a patent claim that is dependent on an independent patent claim can form, without the features of the independent patent claim or only in combination with a subset of the features of the independent patent claim, a separate invention that is independent of the combination of all of the features of the independent patent claim and may be made into the subject matter of an independent claim, a divisional application or a subsequent application. This applies analogously to the technical teaching that is described in the description and may form an invention independent of the features of the independent patent claims.

In one aspect, a device for providing external communication by a (motor) vehicle is described. The vehicle has a steering wheel with one or more light-emitting elements in an interior (i.e. in a passenger compartment) of the vehicle. The one or more light-emitting elements can be arranged on the steering wheel rim of the steering wheel. In particular, the one or more light-emitting elements can extend linearly along the circumference of the steering wheel rim of the steering wheel. The one or more light-emitting elements can then together extend over 50% or more of the circumference of the steering wheel rim of the steering wheel. The one or more light-emitting elements can be configured to generate light signals of different lengths along the circumference of the steering wheel rim of the steering wheel. Alternatively or additionally, the one or more light-emitting elements can be configured to generate light signals of different colors and/or different intensities and/or different flash frequencies.

The one or more light-emitting elements of the steering wheel can be used during the operation of the vehicle to communicate operating information relating to the operation of the steering wheel to the driver of the vehicle. The operating information can in this case concern the automated longitudinal and/or lateral control of the vehicle.

In particular, the device can be configured to exert at least partially automated longitudinal and/or lateral control (for example according to SAE levels 1, 2, 3 or higher) over the vehicle while traveling. The device can furthermore be configured to ascertain operating information relating to the at least partially automated longitudinal and/or lateral control of the vehicle while the vehicle is traveling. The device can furthermore be configured to cause the one or more light-emitting elements to generate a light signal while traveling in order to communicate the operating information to the driver of the vehicle. By providing operating information relating to light signals that are generated by one or more light-emitting elements on the steering wheel, in particular on the steering wheel rim of the steering wheel, of the vehicle, comfortable and reliable operation of the vehicle can be enabled.

The device can be configured to use the one or more light-emitting elements of the steering wheel for external communication by the vehicle (in particular when the vehicle is not traveling and/or when the vehicle is parked). Consequently, it is possible to use one or more existing light-emitting elements of the steering wheel to enable efficient and reliable external communication (with one or more users outside the interior of the vehicle).

For this purpose, the device is configured to ascertain external information that is to be communicated to a user of the vehicle located outside the interior of the vehicle (in particular at a time at which the vehicle is parked). The external information can comprise, among other things: information relating to the interior temperature in the interior of the vehicle; information relating to the state of charge of an electrical energy storage device of the vehicle (which is configured to store electrical energy for the operation of an electric drive motor of the vehicle); and/or information relating to the status of a door, a window, and/or an alarm system of the vehicle.

The device is further configured to cause the one or more light-emitting elements to generate a light signal for indicating external information. Expressed differently, the external information can be indicated via a light signal that is generated by the one or more light-emitting elements on the steering wheel of the vehicle.

The device can be configured here to adapt at least one property of the generated light signal in dependence on the external information that is to be communicated. Examples of properties of the light signal are: the color of the generated light signal; the length of the generated light signal along the circumference of the steering wheel rim of the steering wheel; the intensity of the generated light signal; and/or the flash frequency of the generated light signal.

Due to the (re-)use of the one or more (typically relatively large) light-emitting elements on the steering wheel of the vehicle, reliable and comfortable external communication can be enabled. By adapting one or more properties of the light signal it is then possible to increase the quality and/or the quantity of the external information that has been communicated to the outside.

The device can be configured to ascertain whether the user of the vehicle is located outside the vehicle or not. This can be detected for example on the basis of the position of a user device (for example of a vehicle key and/or a mobile user device, such as a smartphone) belonging to the user. The user device can be embodied and/or used for a keyless access and/or activation function of the vehicle. The position of the user device can be ascertained as part of the keyless access and/or activation function of the vehicle.

The device can furthermore be configured to cause the one or more light-emitting elements to generate the light signal in order to indicate the external information if (in particular only if) it is ascertained that the user of the vehicle is located outside the vehicle. Otherwise, the output of a light signal (and consequently the output of the external information) can be suppressed. In this way, particularly efficient external communication can be made possible.

The device can furthermore be configured to ascertain whether the user of the vehicle is located at a position relative to the vehicle from which a light signal generated by the one or more light emitting elements is visible. For this purpose, positional data regarding the position of the user device relative to the vehicle can be ascertained (for example as part of the keyless access and/or activation function of the vehicle). It is then possible to precisely ascertain on the basis of the positional data whether the user of the vehicle is located at a position relative to the vehicle from which a light signal generated by the one or more light-emitting elements is visible.

The device can furthermore be configured to cause the one or more light-emitting elements to generate the light signal in order to indicate the external information if (in particular only if) it is ascertained that the user of the vehicle is located at a position relative to the vehicle from which a light signal generated by the one or more light-emitting elements is visible. Otherwise, the output of a light signal (and consequently the output of the external information) can be suppressed. In this way, particularly efficient external communication can be made possible.

The device can be configured to ascertain whether the vehicle is parked. This can be ascertained for example on the basis of the status of the transmission, of the drive motor, of the ignition lock, and/or the start button of the vehicle.

Furthermore, the device can be configured to cause the one or more light-emitting elements to generate the light signal in order to indicate the external information if (in particular only if) it is ascertained that the vehicle is parked. Otherwise, the output of a light signal and/or the output of the external information can be suppressed (for example while the vehicle is traveling). In this way, particularly efficient external communication can be made possible.

The device can be configured to determine whether or not a living being (for example a human, such as a child, or an animal) is located in the interior of the vehicle. This can be reliably ascertained on the basis of the sensor data from one or more interior sensors of the vehicle (for example an interior camera and/or an occupancy sensor of a vehicle seat).

It is then possible to ascertain external information relating to the interior temperature in the interior of the vehicle (and to output it via the one or more light-emitting elements) if it is determined that a living being is located in the interior of the vehicle. For example, external information can be ascertained (and output via the one or more light-emitting elements) when the interior temperature reaches or exceeds a specific temperature threshold value. Furthermore, the degree of the interior temperature can be indicated via a property (e.g. the color) of the generated light signal. In this way, the safety of occupants of the vehicle can be increased.

The device can be configured to determine whether or not a charging operation of the electrical energy storage device of the vehicle is being performed at a vehicle-external charging station. It is then possible to ascertain external information relating to the state of charge of the electrical energy storage device (and to output it via the one or more light-emitting elements) if it is determined that a charging operation of the electrical storage device of the vehicle is being performed at a vehicle-external charging station. For example, the state of charge can be indicated by way of the length of the generated light signal. It is thus possible to increase the ease of use during a charging operation of the vehicle.

According to a further aspect, a (road) motor vehicle (in particular a passenger vehicle or a truck or a bus) that comprises the device described in this document is described.

According to a further aspect, a method for providing external communication by a vehicle is described. The vehicle has, in an interior of the vehicle, a steering wheel with one or more (linear) light-emitting elements (which are typically arranged on the steering wheel rim of the steering wheel). The method comprises ascertaining external information to be communicated to a user of the vehicle who is located outside the interior of the vehicle. The method furthermore comprises making the one or more light-emitting elements generate a light signal in order to indicate the external information. The light signal can here be dependent on the external information that is to be communicated.

According to a further aspect, a software (SW) program is described. The SW program can be configured to be executed on a processor (for example on a controller of a vehicle) and to thereby carry out the method described in this document.

According to a further aspect, a storage medium is described. The storage medium can comprise an SW program which is configured to be executed on a processor and to thereby carry out the method described in this document.

The term “automated driving” within this document can be understood to mean driving with automated longitudinal or lateral control or autonomous driving with automated longitudinal and lateral control. The automated driving can be, for example, driving for a prolonged period of time on interstates or highways or driving for a limited period of time during a parking or localized maneuver. The term “automated driving” comprises automated driving of any degree of automation. Examples of degrees of automation are assisted, partially automated, highly automated, or fully automated driving. These degrees of automation were defined by the German Federal Highway Research Institute (BASt) (see BASt publication “Forschung kompakt,” issue November 2012). In assisted driving, the driver continuously exerts longitudinal or lateral control, while the system takes over the respectively other function within certain limits. In partially automated driving (PAD), the system takes over the longitudinal and lateral control for a specific period of time and/or in specific situations, wherein the driver must continuously monitor the system, just as in the case of assisted driving. During highly automated driving (HAD), the system takes over the longitudinal and lateral control for a specific time period without the need for the driver to continuously monitor the system; however, the driver must be able to take control over the vehicle within a specific time. In fully automated driving (FAD), the system can manage driving automatically in all situations for a specific application case; no driver is required for this application case. The aforementioned four degrees of automation correspond to SAE levels 1 to 4 of the SAE J3016 standard (SAE—Society of Automotive Engineering). For example, highly automated driving (HAD) corresponds to level 3 of the SAE J3016 standard. Furthermore, SAE level 5, which is not included in the definition by BASt, is also provided in SAE J3016 as the highest degree of automation. SAE level 5 corresponds to driverless driving, in which the system can automatically manage all situations during the entire journey like a human driver; a driver is generally no longer necessary.

It should be noted that the methods, devices, and systems described in this document can be used alone or in combination with other methods, devices and systems described in this document. Furthermore, any aspects of the methods, devices and systems described in this document can be combined with one another in a variety of ways. In particular, features of the claims can be combined with one another in a variety of ways.

The invention is described below on the basis of exemplary embodiments.

### BRIEF DESCRIPTION OF THE DRAWINGS

FIG. 1a shows examples of components of a vehicle.

FIG. 1b shows an example of a steering wheel of a vehicle.

FIG. 2a shows an example of a vehicle having an access and/or activation function.

FIG. 2b shows an example of a user device.

FIG. 2c shows an example of an arrangement of the user device in relation to the vehicle.

FIG. 3 shows a flowchart of an example of a method for providing external communication for a vehicle.

### DETAILED DESCRIPTION OF THE DRAWINGS

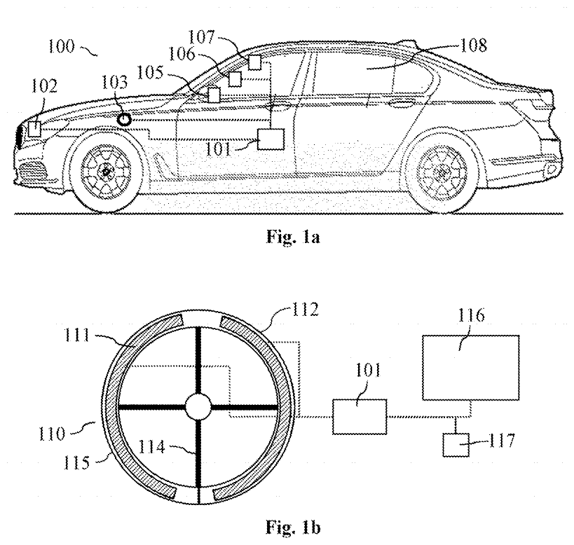

As discussed in the introductory part, the present document concerns the efficient and reliable output of information to a user of a vehicle, who is located outside the interior of the vehicle. In this connection, FIG. 1a shows examples of components of a vehicle 100, in particular of a motor vehicle. The vehicle 100 can comprise one or more vicinity sensors 102 that are configured to pick up sensor data (in this document also referred to as vicinity data) relating to the vicinity of the vehicle 100. Examples of vicinity sensors 102 are a camera, a radar sensor, a lidar sensor, an ultrasonic sensor, etc.

The vehicle 100 furthermore comprises one or more longitudinal and/or lateral control actuators 103 (for example a drive motor, a brake device, a steering device, etc.) that are configured to exert longitudinal and/or lateral control over the vehicle 100 automatically or in an automated fashion. A control unit 101 (or a device) of the vehicle 100 can be configured to operate the one or more longitudinal and/or lateral control actuators 103 of the vehicle in dependence on the vicinity data in order to exert longitudinal and/or lateral control over the vehicle 100 in an automated fashion (in particular according to SAE level 1, according to SAE level 2, according to SAE level 3 or higher).

The vehicle 100 comprises one or more manual controllers 105 in the interior or in the passenger compartment 108 of the vehicle 100. The one or more controllers 105 allow the driver of the vehicle 100 to enter manual control inputs relating to the longitudinal and/or lateral control of the vehicle 100. Examples of controllers 105 are: a steering wheel, a brake pedal, and/or an accelerator pedal. The control unit 101 can be configured to detect (in particular when the vehicle 100 is operated in a manual driving mode) a manual control input at a manual controller 105 of the vehicle 100. Furthermore, the control unit 101 can be configured to operate the one or more longitudinal and/or lateral control actuators 103 of the vehicle 100 in dependence on the manual control input, in particular in order to allow the driver of the vehicle 100 to manually exert longitudinal and/or lateral control over the vehicle 100.

The vehicle 100 can comprise a user interface 106 in the interior 108 of the vehicle 100, which user interface 106 enables interaction between the vehicle 100 and the driver of the vehicle 100. The user interface 106 can comprise one or more operating elements (e.g. a button, a rotary knob, etc.) and/or one or more output elements (e.g. a screen, a light-emitting element, a loudspeaker, etc.). The control unit 101 can be configured to output a visual, haptic, and/or acoustic notification to the driver of the vehicle 100 via the user interface 106. Furthermore, it is possible to enable the driver of the vehicle 100 to activate or deactivate one or more driving functions of different degrees of automation via the user interface 106.

FIG. 1b shows examples of components of a vehicle 100 at the driver position of the vehicle 100. In particular, FIG. 1b shows a steering wheel 110 as an example of a manual controller 105 which enables the driver of the vehicle 100 to manually steer the vehicle 100. One or more contact sensors (not illustrated) can be arranged on the steering wheel 110, which contact sensors are configured to detect whether at least one hand of the driver of the vehicle 100 is in contact with the steering wheel 110. The control unit 101 can be configured to determine on the basis of the sensor data from the one or more contact sensors of the steering wheel 110 whether at least one hand of the driver of the vehicle 100 is in contact with the steering wheel 110, if both hands are in contact therewith, or whether the driver is not in contact with the steering wheel. FIG. 1b furthermore shows, as examples of components of the user interface 106, a screen 116 and a loudspeaker 117.

The steering wheel 110 furthermore has one or more light-emitting elements 111, 112, which can be activated or deactivated. A light-emitting element 111, 112 preferably has an elongate shape. In particular, a light-emitting element 111, 112 can be embodied such that the light-emitting element 111, 112 extends linearly along the circumference of the steering wheel rim 115. For example, a light-emitting element 111, 112 can extend along the circumference of the steering wheel rim 115 over an angle range of 45° or more, in particular of 90° or 120° or more. The vehicle 100 can have, for example, one light-emitting element 111 on the left half of the rim and one light-emitting element 112 on the right half of the rim of the steering wheel rim 115.

A linear light-emitting element 111, 112 can have a plurality of partial segments (in each case having one or more LEDs), which can be activated or deactivated in each case individually. In other words, a linear light-emitting element 111, 112 can be embodied such that, where appropriate, only part of the light-emitting element 111, 112 is activated so that the length of a linear light signal emitted by the light-emitting element 111, 112 can be changed, in particular reduced or increased.

The control unit 101 of the vehicle 100 can be configured to indicate information relating to the driving operation via the one or more light-emitting elements 111, 112 on the steering wheel 110 of the vehicle 100 during the operation of the vehicle 100. For this purpose, one or more properties of a light-emitting element 111, 112 can be set. Examples of properties are: the color, the length, and/or the intensity of the light-emitting element 111, 112. Examples of information that can be output via the one or more light-emitting elements 111, 112 are: the current degree of automation, in particular SAE level, of the vehicle 100; a request to manually take over the driving operation; a warning, etc.

Furthermore, the one or more light-emitting elements 111, 112 of the steering wheel 110 of the vehicle 100 can be used for external communication in order to provide (external) information to a user located outside the passenger compartment 108. Owing to the arrangement of the steering wheel 110 inside the passenger compartment 108 and/or owing to the size of the one or more light-emitting elements 111, 112, a light signal that is emitted by a light-emitting element 111, 112 is typically relatively easily visible from the outside.

The control unit 101 (in this document also referred to as device) can be configured to ascertain external information that is to be output or communicated to a user located outside the passenger compartment 108 of the vehicle 100. Furthermore, the control unit 101 can be configured to operate the one or more light-emitting elements 111, 112, which indicate external information by generating one or more light signals. It is thus possible to efficiently enable reliable external communication.

Various states can be indicated appropriately for a respective situation with the aid of the light-emitting steering wheel 110 of the vehicle 100. For example, the interior temperature in the passenger compartment 108 of the vehicle 100 can be indicated (e.g. if children are located in the passenger compartment 108 of the vehicle 100). The control unit 101 can be configured to detect on the basis of the sensor data from at least one interior sensor 107 (e.g. an internal camera, a seat occupancy sensor, etc.) whether or not there is an occupant and/or an animal in the interior 108 of the vehicle 100. If it is detected that there is an occupant and/or an animal in the interior 108, and if it is detected that the temperature in the interior 108 has reached or exceeds a specific temperature threshold value, a light signal can be output by the one or more light-emitting elements 111, 112. It is possible thereby to indicate information relating to the temperature level using a property of the light signal (e.g. the color and/or the repetition frequency), for example “yellow” for a medium temperature, “red” for a high temperature, and/or “flashing red” for a very high temperature.

Alternatively or additionally, the control unit 101 can be configured to detect that the electrical energy storage device of the vehicle 100 is being charged. The one or more light-emitting elements 111, 112 can then be used as state-of-charge indicator during the charging operation. The length of the light signal generated can here be increased as the state of charge increases. In this way, the state of charge of the electrical energy storage device of the vehicle 100 can be reliably gathered by a user of the vehicle 100 from the outside.

Alternatively or additionally, the status (e.g. opened or closed) of a door or of a window of the vehicle 100 can be indicated as the external information. Alternatively or additionally, the status (e.g. activated; doors locked but alarm system deactivated; etc.) of the alarm system of the vehicle 100 can be indicated.

The control unit 101 can be configured to ascertain whether a user (e.g. the driver) of the vehicle 100, in particular a potential receiver for the external information, is located outside the vehicle 100. The control unit 101 can furthermore be configured to check whether the user is located at a position in relation to the vehicle 100 from which the light signal of the one or more light-emitting elements 111, 112 of the vehicle 100 can be seen by the user. The control unit 101 can furthermore be configured to output the light signal, where appropriate, only if it is detected that a user is located outside the vehicle 100 and/or if it is detected that the user is located at a position from which the light signal can be seen. The reliability and efficiency of the external communication can in this way be increased further.

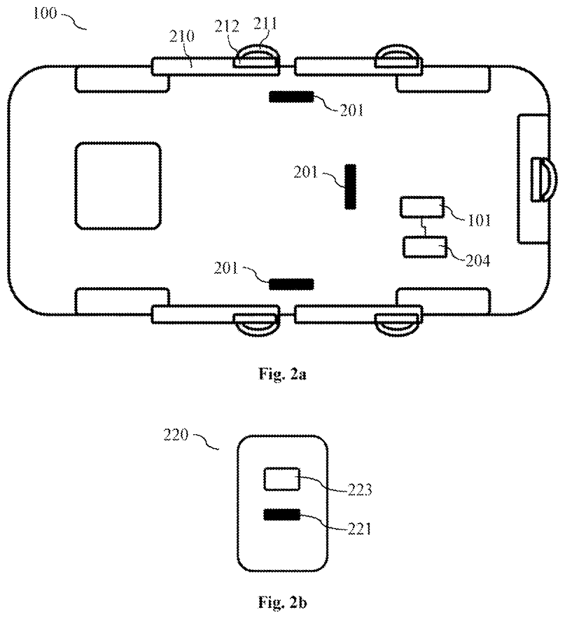

FIG. 2a shows an example of a vehicle 100, and FIG. 2b shows an example of a user device 220 (e.g. a vehicle key and/or a mobile user device, such as a smartphone) belonging to the user, which provide a keyless access and/or activation function or which together form an access and/or activation system. A keyless access and/or activation function enables a user of a vehicle 100 to open a vehicle door 210 and/or to start the motor of the vehicle 100 without using the key-lock principle. For opening the door 210, the driver reaches for the door handle 211. A proximity sensor 212 at or near the door handle 211 detects this movement.

A specific radio signal (e.g. in the low-frequency, LF, range or with Bluetooth Low Energy (BLE) or an ultra-wideband (UWB) radio protocol) can be transmitted via one or more transmission units 201 of the vehicle 100, where appropriate, in reaction to a detected approach or periodically. This radio signal can also be referred to as a request signal. In other words, the one or more transmission units 201 of the vehicle 100 can be configured to transmit an electromagnetic signal, i.e. the request signal. Examples of transmission frequencies of the one or more transmission units 201 lie in the frequency range of 20-140 kHz (e.g. 20 kHz, 124 kHz, 125 kHz, 127 kHz, 133 kHz, or 135 kHz). Alternatively, frequencies in the range of 2.4 GHz (for example when using BLE (Bluetooth Low Energy) or UWB (ultra-wideband)) can be used (in order to enable greater ranges and/or higher precision of the localization). Furthermore, BLE and/or UWB can advantageously be used in connection with smartphones as the user device 220.

The user device 220 can be configured to receive request signals in the LF (low frequency) range and/or in the UWB frequency range. A combined ability to receive LF and UWB request signals can be advantageous in particular for a radio key as the user device 220.

Alternatively or additionally to the localization of the user device 220 as a reaction to making contact with a door handle 211, the approach or the nearness of a user to a vehicle 100 can already trigger a localization of the user device 220 (in particular the determination of the position coordinates of the position of the user device 220 in relation to the vehicle 100). As a reaction to the localization of the user device 220, one or more functions can then be triggered and/or enabled.

The request signal transmitted by the one or more transmission units 201 can comprise several parts. A first part of the request signal can be designed to wake up a receiving unit 223 in a user device 220 or to place it into an operating mode, i.e. to prepare it for the reception of further information. A further part of the request signal can comprise information for identifying the vehicle 100 and/or for uniquely identifying the request signal. The different parts of the request signal transmitted in each case by the one or more transmission units 201 can be transmitted with a time offset.

The receiving unit 223 in the user device 220 is configured to receive the signals or signal parts transmitted by the one or more transmission units 201 and to ascertain the signal strength or field strength and/or the time of flight of the signals or signal parts. A transmission unit 221 of the user device 220 responds to the received request signal with a response signal. The response signal can be transmitted in a different frequency range than the one or more request signals. For example, the response signal can be transmitted with a response frequency of 433 MHz (i.e. in the radio frequency (RF) range). Alternatively, frequencies in the range from 2.4 GHz (e.g. when using BLE) and/or in the range of UWB can be used.

The response signal can consist of several parts. A first part of the response signal can be used to identify the user device 220 (e.g. an authentication key can be transmitted), and a further part of the response signal can comprise signal strength information and/or time-of-flight information with respect to the measured signal strength and/or time-of-flight of the request signal. One or more receiving units 204 of the vehicle 100 can receive the response signal and/or the response signal parts and pass them on to the control unit 101 of the vehicle 100.

The control unit 101 can be configured to check whether the user device 220 matches the vehicle 100. In particular, an authentication of the user device 220 can take place. Furthermore, triangulation or trilateration or a lookup table can be used to calculate the position of the user device 220 in relation to the vehicle 100 (on the basis of the measured signal strengths and/or times of flight of a plurality of request signals).

As illustrated in FIG. 2a, the vehicle 100 typically comprises a plurality of transmission units 201. The transmission units 201 can be arranged at different points (i.e. a different reference points) in the vehicle 100. Each transmission unit 201 of the plurality of transmission units 201 can transmit one request signal (e.g. one signal pulse). The request signals can be sent with a time offset and possibly in a predefined order. Alternatively or additionally, the request signals can have a unique identifier. The user device 220 and/or the receiving unit 204 of the vehicle 100 can uniquely assign the request signals in each case to a transmission unit 201 of the plurality of transmission units 201 on the basis of the identifier and/or on the basis of the order. It is thus possible for the respective signal strength and/or time of flight of the individual request signals and consequently also for the respective distance between the transmission unit 201 (i.e. reference point) and the user device 220 to be ascertained. Since the transmission units 201 are located at different points (i.e. at different reference points) in the vehicle 100, this gives a plurality of distances for the corresponding plurality of transmission units 201. It is thus possible to determine the relative position between the vehicle 100 and the user device 220 on the basis of triangulation or trilateration methods.

Consequently, the position of a user, in particular the position of a user device 220, in relation to the vehicle 100 can be ascertained precisely. For example it is possible to ascertain whether or not the user or the user device 220 is located within a defined surrounding area 230 of the vehicle 100. If this is the case, it can be assumed that the user is located at a position from which the light signal can be perceived by the user. In particular, the output of the external information can be brought about via the one or more light-emitting elements 111, 112 of the steering wheel 110. In addition, the output of the external information via the one or more light-emitting elements 111, 112 of the steering wheel 110 can be suppressed. In this way, particularly efficient external communication can be achieved.

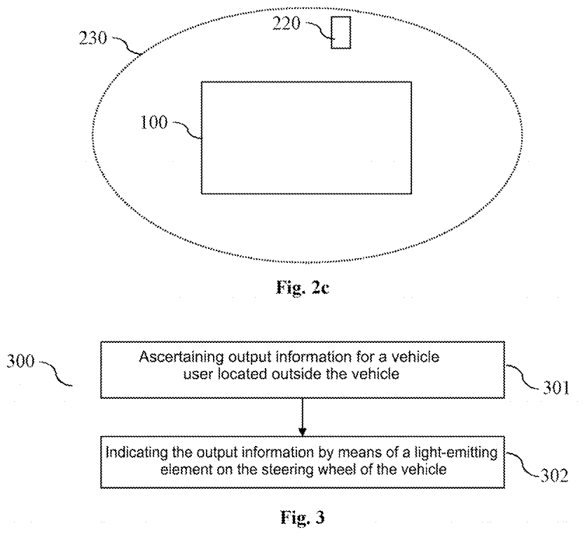

FIG. 3 shows a flowchart of an example of a (computer-implemented) method 300 for providing external communication by a (motor) vehicle 100. The vehicle 100 has a steering wheel 110 with one or more light-emitting elements 111, 112 in the interior or in the passenger cabin 108 of the vehicle 100. The one or more light-emitting elements 111, 112 can extend linearly along the circumference of the steering wheel rim 115 of the steering wheel 110. Furthermore, the one or more light-emitting elements 111, 112 can be arranged on the steering wheel rim 115 in a manner such that a light signal generated by the one or more light-emitting elements 111, 112 is visible at the driver position of the vehicle 100.

The method 300 comprises ascertaining 301 external information that is to be communicated to a user (in particular to the driver) of the vehicle 100 who is located outside the interior 108 of the vehicle 100. In particular, it is possible as part of the method 300 to ascertain whether a user of the vehicle 100 for whom the external information is intended is located outside the interior 108 of the vehicle 100.

The method 300 furthermore comprises bringing about 302 that the one or more light-emitting elements 108 generate a light signal in order to indicate the external information. The light signal can in particular be brought about 302 if it is detected that the user for whom the external information is intended is located outside the interior 108 of the vehicle 100. The light signal can here be brought about in dependence on the external information that is to be communicated, in particular the color, the length, and/or the flash frequency of the generated light signal can be selected in dependence on the external information that is to be communicated.

By using the one or more light-emitting elements 111, 112 on the steering wheel 110 of a vehicle 100 for communicating with a user located outside the vehicle 100, reliable and comfortable external communication can be enabled.

The present invention is not limited to the exemplary embodiments shown. In particular it is noteworthy that the description and the figures are intended to illustrate the principle of the proposed methods, devices, and systems merely by way of example.

1.-12. (canceled)

13. A device for providing external communication by a vehicle, wherein the vehicle comprises a steering wheel with one or more light-emitting elements in an interior of the vehicle, wherein the device is configured:
to ascertain external information that is to be communicated to a user of the vehicle located outside of the interior of the vehicle; and
to cause the one or more light-emitting elements to generate a light signal in order to indicate the external information.

14. The device according to claim 13, wherein the device is further configured:
to ascertain whether or not the user of the vehicle is located outside of the vehicle; and
to cause the one or more light-emitting elements to generate the light signal in order to indicate the external information upon ascertaining that the user of the vehicle is located outside of the vehicle.

15. The device according to claim 14, wherein the device is further configured:
to ascertain whether or not the user of the vehicle is located outside of the vehicle; and
to cause the one or more light-emitting elements to generate the light signal in order to indicate the external information only upon ascertaining that the user of the vehicle is located outside of the vehicle.

16. The device according to claim 13, wherein the device is further configured:
to ascertain whether the user of the vehicle is located at a position in relation to the vehicle from which the light signal generated by the one or more light-emitting elements is visible; and
to cause the one or more light-emitting elements to generate the light signal in order to indicate the external information upon ascertaining that the user of the vehicle is located at the position in relation to the vehicle from which the light signal generated by the one or more light-emitting elements is visible.

17. The device according to claim 13, wherein the device is further configured:
to ascertain whether the user of the vehicle is located at a position in relation to the vehicle from which the light signal generated by the one or more light-emitting elements is visible; and
to cause the one or more light-emitting elements to generate the light signal in order to indicate the external information only upon ascertaining that the user of the vehicle is located at the position in relation to the vehicle from which the light signal generated by the one or more light-emitting elements is visible.

18. The device according to claim 17, wherein the device is further configured:
to provide a keyless access and/or activation function of the vehicle using a user device;
to ascertain positional data regarding the position of the user device in relation to the vehicle; and
to ascertain, based on the positional data, whether the user of the vehicle is located at the position in relation to the vehicle from which the light signal generated by the one or more light-emitting elements is visible.

19. The device according to claim 13, wherein the device is further configured:
to ascertain whether the vehicle is parked; and
to cause the one or more light-emitting elements to generate the light signal in order to indicate the external information upon ascertaining that the vehicle is parked.

20. The device according to claim 13, wherein the device is further configured:
to ascertain whether the vehicle is parked; and
to cause the one or more light-emitting elements to generate the light signal in order to indicate the external information only upon ascertaining that the vehicle is parked.

21. The device according to claim 13, wherein the external information comprises at least one of:
information relating to an interior temperature in the interior of the vehicle;
information relating to a state of charge of an electrical energy storage device of the vehicle; or
information relating to a status of at least one of a door, a window, or an alarm system of the vehicle.

22. The device according to claim 13, wherein:
the device is further configured to adapt at least one property of the generated light signal based on the external information that is to be communicated; and
the at least one property compromises at least one of:
a color of the generated light signal;
a length of the generated light signal along a circumference of the steering wheel;
an intensity of the generated light signal; or
a flash frequency of the generated light signal.

23. The device according to claim 13, wherein the device is further configured:
to determine whether or not a living being is located in the interior of the vehicle; and
to ascertain the external information in relation to an interior temperature in the interior of the vehicle upon determining that the living being is located in the interior of the vehicle.

24. The device according to claim 13, wherein the device is further configured:
to determine whether or not a charging operation of an electrical energy storage device of the vehicle is being performed at a vehicle-external charging station; and
to ascertain the external information relating to a state of charge of the electrical energy storage device upon determining that the charging operation of the electrical energy storage device of the vehicle is being performed at the vehicle-external charging station.

25. The device according to claim 13, wherein the device is further configured:
to exert at least one of longitudinal or lateral control over the vehicle in an at least partially automated fashion during traveling;
to ascertain operating information in relation to the at least one of longitudinal or lateral control of the vehicle while the vehicle is traveling; and
to cause the one or more light-emitting elements, while traveling, to generate the light signal in order to communicate the operating information to a driver of the vehicle.

26. The device according to claim 13, wherein at least one of:
the one or more light-emitting elements together extend over 50% or more along a circumference of the steering wheel;
the one or more light-emitting elements are configured to generate light signals of different lengths along the circumference of the steering wheel; or
the one or more light-emitting elements are configured to generate light signals of at least one of different colors, different intensities, or different flash frequencies.

27. A method for providing external communication by a vehicle, wherein the vehicle has a steering wheel having one or more light-emitting elements in an interior of the vehicle, the method comprising:
ascertaining external information that is to be communicated to a user of the vehicle located outside of the interior of the vehicle; and
causing the one or more light-emitting elements generate the light signal in order to indicate the external information.
